(19) United States
(12) Patent Application Publication
(10) Pub. No.: US 2026/0058361 A1
(43) Pub. Date: Feb. 26, 2026

(54) ANTENNA DEVICE WITH A ROTATABLE MIRROR

(71) Applicant: Pivotal Commware, Inc., Bothell, WA (US)

(72) Inventor: Jay Howard McCandless, Las Vegas, NV (US)

(21) Appl. No.: 18/811,284

(22) Filed: Aug. 21, 2024

(51) Int. Cl. H01Q 3/20; H01Q 13/02

(52) U.S. Cl. CPC H01Q 3/20; H01Q 13/02

(57) ABSTRACT

An example steerable antenna device includes a support, such as a framework or housing, with a horn antenna at one end to transmit microwave radiation along a zenith axis for beam steering. A mirror rotatably connected to the support reflects the radiation as beam-steered microwave radiation. In some examples, the mirror is tiltable for elevation angle control. In some examples, the mirror is rotatable for controlling the beam steering azimuth angle. A knob connected to the mirror allows manual rotation around the zenith axis.

### BACKGROUND

Previous approaches to steerable antenna devices have typically involved complex mechanical and electronic systems to achieve beam steering capabilities. For example, mechanical systems used for beam steering often require multiple components, such as motors, gears, and controllers, to adjust the direction of the transmitted radiation. The mechanical systems used for beam steering have traditionally been bulky and prone to wear and tear over time, leading to decreased accuracy and reliability in controlling the direction of the antenna beam. For example, the mechanical movement of a directive antenna for pointing in different directions requires complex wire/cable management, stronger and more complex components for heavy antennas and associated heatsinks. Additionally, mechanical solutions can be especially challenging when dual polarization is required.

Electronic beam steering systems have also been developed, utilizing, for example, phased array antennas to adjust the direction of the transmitted radiation. While these systems offer advantages in terms of speed and precision in beam steering, they often require sophisticated control algorithms and signal processing techniques to operate effectively. Additionally, electronic beam steering systems can be costly to implement and maintain, limiting their practicality for certain applications.

Another approach to achieving beam steering in antenna devices involves the use of mechanical actuators to physically adjust the position of the antenna elements. These actuators can be used to tilt or rotate the antenna elements to control the direction of the transmitted radiation. However, mechanical actuators can introduce mechanical complexity and potential points of failure in the system. Additionally, the physical movement of the antenna elements can introduce unwanted vibrations and mechanical noise, which can impact the overall performance of the antenna device.

### BRIEF DESCRIPTION OF THE DRAWINGS

FIG. 1 illustrates a perspective view of an example steerable antenna device, according to one embodiment.

FIG. 2 illustrates an exploded view of some components of an example steerable antenna device, according to one embodiment.

FIG. 3A illustrates a mirror of an example steerable antenna device rotated around a zenith axis to a first position, according to one embodiment.

FIG. 3B illustrates the mirror of the steerable antenna device rotated around the zenith axis to a second position, according to one embodiment.

FIG. 4 illustrates another perspective view of an example steerable antenna device with a horn and transducer, according to one embodiment.

FIG. 5A illustrates one half of a split block horn, according to one embodiment.

FIG. 5B illustrates two halves of a split block horn, according to one embodiment.

FIG. 6A illustrates a perspective view of an example steerable antenna device with a mounting structure, according to one embodiment.

FIG. 6B illustrates the steerable antenna device with the mirror rotated for beam steering at a first azimuth angle, according to one embodiment.

FIG. 6C illustrates the steerable antenna device with the mirror rotated for beam steering at a second azimuth angle, according to one embodiment.

FIG. 6D illustrates the steerable antenna device with the mirror rotated for beam steering at a third azimuth angle, according to one embodiment.

FIG. 7A illustrates an example steerable antenna device with a mirror selectively tilted to a lower elevation angle, according to one embodiment.

FIG. 7B illustrates the steerable antenna device with the mirror selectively tilted to a higher elevation angle, according to one embodiment.

FIG. 8 illustrates a steerable antenna device with motorized mirror control, according to one embodiment.

FIG. 9A illustrates a perspective view of an example steerable antenna device with a wedge mirror at a first azimuth angle, according to one embodiment.

FIG. 9B illustrates a perspective view of the steerable antenna device of FIG. 9A with the wedge mirror rotated to a second azimuth angle, according to one embodiment.

FIG. 10A illustrates a perspective view of an example steerable antenna device with dual rotatable mirrors rotated to two independent azimuth angles, according to one embodiment.

FIG. 10B illustrates a perspective view of the steerable antenna device of FIG. 10A with dual rotatable mirrors rotated to two different independent azimuth angles, according to one embodiment.

FIG. 11 illustrates a graph of the gain achieved by an example steerable antenna device at various steering angles for various frequencies, according to one embodiment.

### DETAILED DESCRIPTION

According to various embodiments, a steerable antenna device includes support (e.g., a framework or housing), an antenna, and a mirror. For example, a horn, dipole, slot, or patch antenna may be positioned near the first end of the support to transmit microwave or millimeter wave radiation toward the second end of the support. The radiation may be transmitted along a first path that defines a zenith axis for beam steering. The mirror is rotatably secured to the second end of the support and positioned within the radiation path to reflect the radiation as beam-steered radiation. The support may be a radome (for example, a circular, oval, elliptical cylindrical housing, or even a partial spherical housing). Alternatively, the support may comprise one or more columns, beams, struts, and/or frameworks.

In various embodiments, the mirror can be rotated around the zenith axis to control the azimuth angle. In some embodiments, the mirror can also be tiltable. That is, the mirror may be selectively tilted relative to the zenith axis to control the elevation angle of the beam-steered radiation. In some implementations, a knob is connected to the mirror. An operator can rotate the knob to manually rotate the mirror around the zenith axis with respect to the support. In some embodiments, the mirror can be fully rotated around the zenith axis 360 degrees, corresponding to beam steering azimuth angles between 0 and 360 degrees. In other embodiments, a blocking control strut or other stop element may limit the rotation to a target rotational range. For example, a blocking control strut may limit clockwise rotation from 0 degrees to 170 degrees and counterclockwise rotation from 0 degrees to −170 degrees.

In some embodiments, the mirror may be rotatably secured to the second end of the support via a mirror support. The mirror may extend below the second end of the support (e.g., into the housing) for selective positioning of the mirror at a target distance from the underlying antenna. The knob may be connected to the mirror directly and/or connected to the mirror via the mirror support. The knob may be any size. In some embodiments, the knob extends from the housing. In other embodiments, the knob is recessed within the housing. In still other embodiments, a motor or linear actuator is connected to the knob, the mirror support, and/or directly to the mirror (e.g., via a shaft). A controller actuates the stepper or rotary motor to selectively rotate the mirror.

In some examples, the mirror is tilted at a fixed angle between 30 and 60 degrees (e.g., 45 degrees) relative to the zenith axis. With the mirror tilted at a 45-degree angle relative to the zenith axis, the beam is steered at an elevation angle orthogonal to the zenith axis (e.g., at a zero-degree elevation angle). In the illustrated examples, the support is shown as a cylindrical housing, and the mirror is a circle. However, in some embodiments, the housing may be another shape, the support may be something other than a fully enclosed housing (e.g., a framework of pillars or struts), and/or the mirror may be asymmetrical.

In some embodiments, the reflective surface of the mirror has an asymmetrical surface, regardless of whether the mirror is circular. In some embodiments, the mirror can be rotated about a perpendicular axis to modify the polarization of the beam-steered radiation. In some embodiments, one or more adjustment shafts are used to adjust the tilt angle of the mirror. The shafts can be driven by linear actuators for electronic elevation scanning. For example, the mirror may be tilt-adjustable between 35 degrees and 55 degrees relative to the zenith axis, corresponding to beam steering elevation angles between −15 degrees and 15 degrees. Larger tilt ranges may be implemented in some embodiments (e.g., from 25 degrees to 70 degrees relative to the zenith axis).

In various embodiments, the antenna may include a rectangular, square, or circular horn. In other embodiments, the antenna may be a horn, patch antenna, patch array, or other antenna. In various embodiments, the antenna may support single or dual polarization (e.g., linear or circular polarization). The mirror may be fabricated using a reflective material selected for the operational wavelengths. For example, the mirror may be a flat metallic surface, such as aluminum, or a metal-coated dielectric material (e.g., an aluminum layer deposited on a lightweight plastic surface). The mirror may rotate the polarization by the reflection but otherwise support single or dual polarization.

Some of the infrastructure that can be used with embodiments disclosed herein is already available, such as general-purpose computers, computer programming tools and techniques, digital storage media, and communication links. Many of the systems, subsystems, modules, components, and the like that are described herein may be implemented as hardware, firmware, and/or software. Various systems, subsystems, modules, and components are described in terms of the function(s) they perform because such a wide variety of possible implementations exist. For example, it is appreciated that many existing programming languages, hardware devices, frequency bands, circuits, software platforms, networking infrastructures, and/or data stores may be utilized alone or in combination to implement a specific control function.

It is also appreciated that two or more of the elements, devices, systems, subsystems, components, modules, etc., that are described herein may be combined as a single element, device, system, subsystem, module, or component. Moreover, many elements, devices, systems, subsystems, components, and modules may be duplicated or further divided into discrete elements, devices, systems, subsystems, components, or modules to perform subtasks of those described herein. Any of the embodiments described herein may be combined with any combination of other embodiments described herein. The various permutations and combinations of embodiments and elements of embodiments are contemplated to the extent that they do not contradict one another.

As used herein, a computing device, system, subsystem, module, or controller may include a processor, such as a microprocessor, a microcontroller, logic circuitry, or the like. A processor may include one or more special-purpose processing devices, such as an application-specific integrated circuit (ASIC), a programmable array logic (PAL), a programmable logic array (PLA), a programmable logic device (PLD), a field-programmable gate array (FPGA), and/or another customizable and/or programmable device. The computing device may also include a machine-readable storage device, such as non-volatile memory, static RAM, dynamic RAM, ROM, disk, tape, magnetic, optical, flash memory, and/or another machine-readable storage medium. Various aspects of certain embodiments may be implemented or enhanced using hardware, software, firmware, or a combination thereof.

The components of some of the disclosed embodiments are described and illustrated in the figures herein. Many portions thereof could be arranged and designed in a wide variety of different configurations. Furthermore, the features, structures, and operations associated with one embodiment may be applied to or combined with the features, structures, or operations described in conjunction with another embodiment. In many instances, well-known structures, materials, or operations are not shown or described in detail to avoid obscuring aspects of this disclosure. The right to add any described embodiment or feature to any one of the figures and/or as a new figure is explicitly reserved.

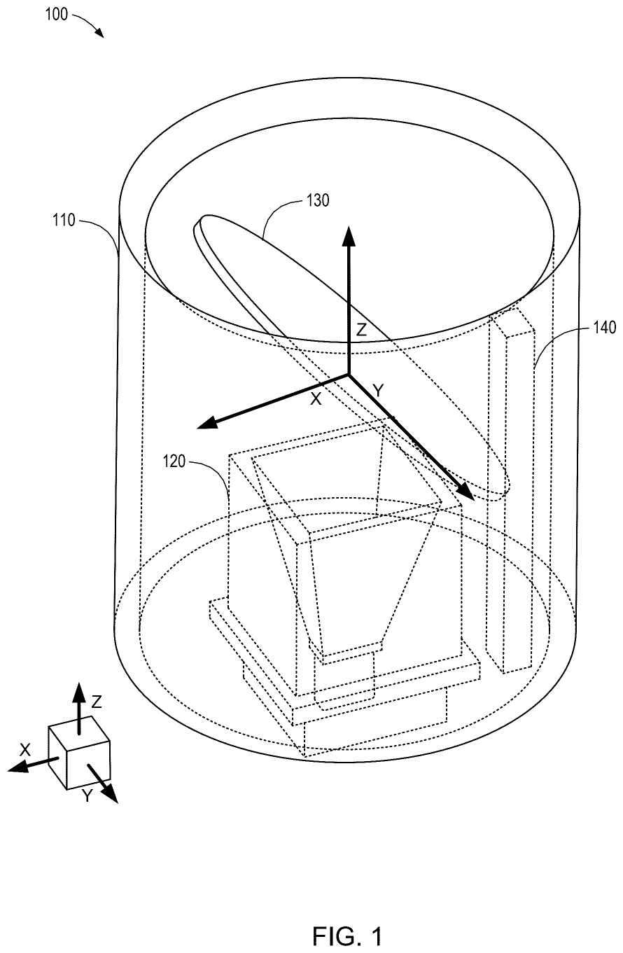

FIG. 1 illustrates a perspective view of an example steerable antenna device 100, according to one embodiment. In the illustrated example, the steerable antenna device 100 includes a cylindrical housing 110 that is transparent to the desired frequencies of operation. The cylindrical housing 110 may be made from plastic, ceramic, or other material. For example, the cylindrical housing 110 may be polycarbonate. A horn antenna 120 is positioned at one end of the cylindrical housing 110 to transmit radiation toward the second end of the support along a first radiation path that defines a zenith axis for beam steering. The zenith axis is labeled the Z-axis in the illustrated example. A mirror 130 is rotatably secured to the cylindrical housing 110 and positioned within the first radiation path to reflect the microwave radiation as beam-steered microwave radiation.

In alternative embodiments, the housing 110 may be replaced by an alternative support structure, such as pillars or struts to rotationally secure the mirror 130 at a fixed distance relative to the horn antenna 120. In some embodiments, including in the illustrated embodiment, a blocking strut 140 may prevent rotation of the mirror 130 to some azimuth angles, increase the strength of the cylindrical housing 110, and/or provide a conduit for wires and/or sensors in electronically controlled embodiments.

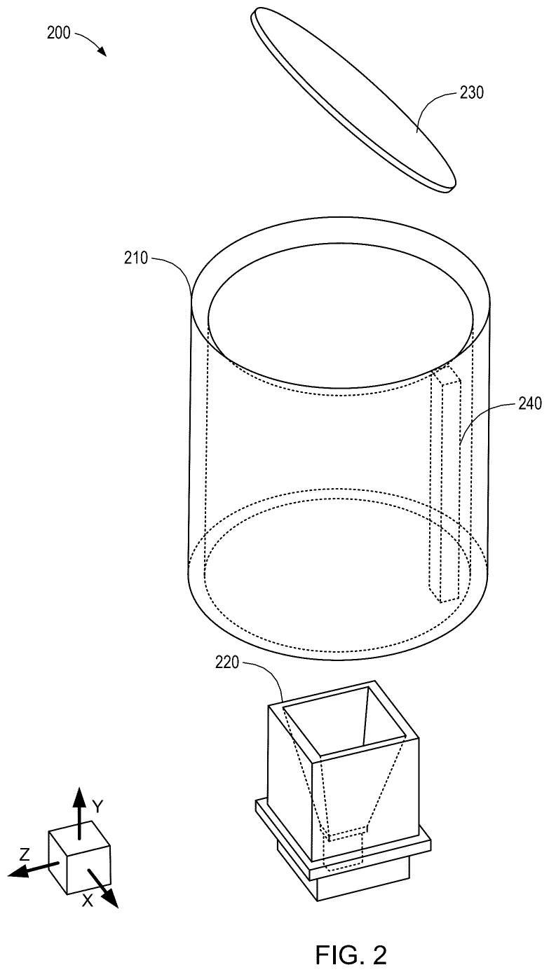

FIG. 2 illustrates an exploded view of some components of an example steerable antenna device 200, according to one embodiment. Again, the support is illustrated as a cylindrical housing 210 with a blocking strut 240. A mirror 230 is rotatably secured within the cylindrical housing 210. An antenna, such as the illustrated horn antenna 220, is positioned proximate to the other end of the cylindrical housing 210.

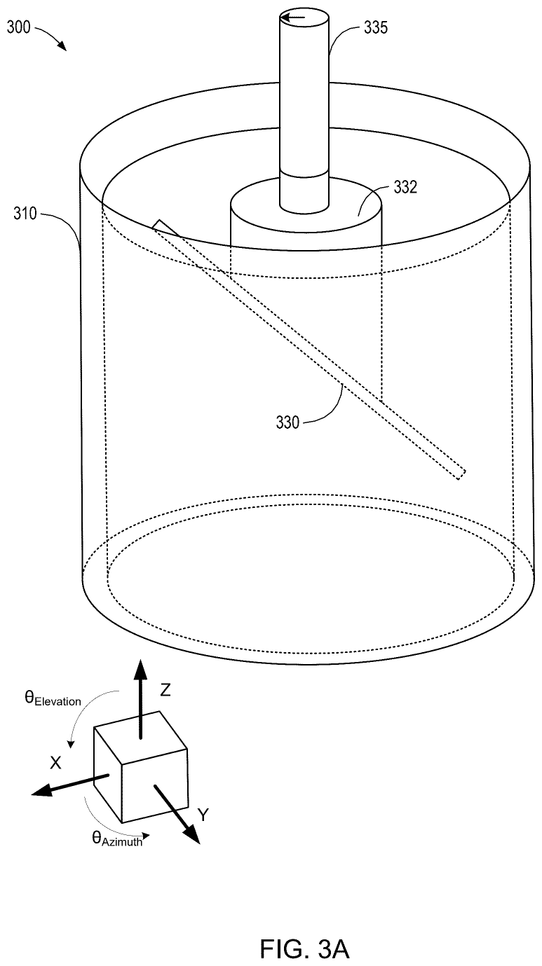

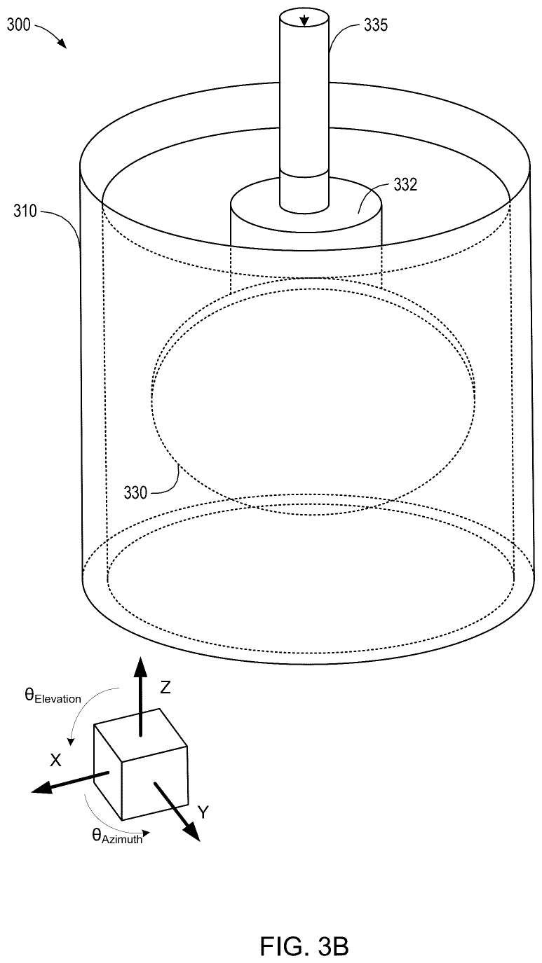

FIG. 3A illustrates a mirror 330 of an example steerable antenna device 300 rotated around a zenith axis to a first position, according to one embodiment. In the illustrated embodiment, the mirror 330 is rotatably connected to the cylindrical housing 310 via a mirror support 332. The mirror support 332 may be, for example, rotatably connected to the top or lid of the cylindrical housing 310. In some embodiments, the mirror support 332 may be rotatably connected to the cylindrical housing 310 using bearings, an axle, friction fittings, and/or other thru-bore connections. A knob 335 extends from the mirror support 332 through the top or second end of the cylindrical housing 310. The knob 335 can be rotated to rotate the mirror 330 within the cylindrical housing 310.

FIG. 3B illustrates the mirror 330 of the steerable antenna device 300 rotated around the zenith axis to a second position, according to one embodiment. The face of the mirror may be flat, symmetrically concave to increase directivity, and/or asymmetrically concave or curved to modify the shape of a reflected beam. In some instances, a fatter or wider beam is desired, and the mirror can be shaped to be convex, faceted, or wedge shaped in the azimuth direction and/or elevation direction. In various embodiments, the mirror shape may be selected to achieve target focusing or defocusing effects. In various embodiments, the mirror can be swapped with a mirror having a different shape before or after installation without any modification to the antenna or other components. In some embodiments, the shape of the mirror can also be electronically modified (e.g., by incorporating an electrically conductive polymer, electroactive polymer, a ceramic piezoelectric material, fluoropolymer surface, or the like into the mirror).

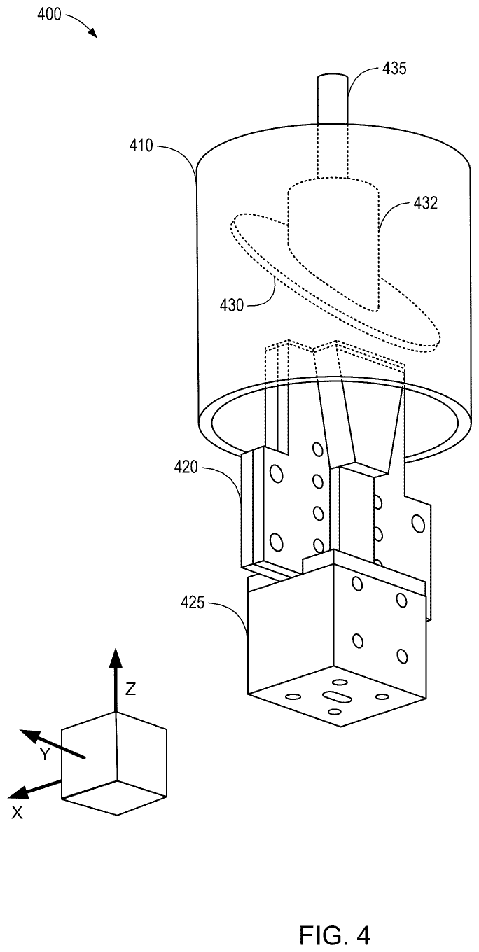

FIG. 4 illustrates another perspective view of an example steerable antenna device 400 with a horn 420 and transducer 425, according to one embodiment. The transducer 425 may be, for example, an orthogonal mode transducer. A wide variety of transmitters, receivers, or transceivers may be utilized instead of an orthogonal mode transducer and horn. The horn 420 is illustrated as a split horn with two halves joined together. The transducer 425 and the horn 420 operate as a directive antenna to transmit beamformed radiation along the vertical axis (Z-axis) or zenith of the steerable antenna device 400.

The mirror 430 operates to reflect the radiation transmitted along the vertical axis at a 90-degree angle (or another angle if the mirror is tilted to an angle other than 45 degrees relative to the zenith). The mirror 430 is attached to a mirror support 432 and a knob 435. In the illustrated embodiment, the mirror support 432 is rotatably attached to an upper portion or lid (not shown) of the cylindrical housing 410.

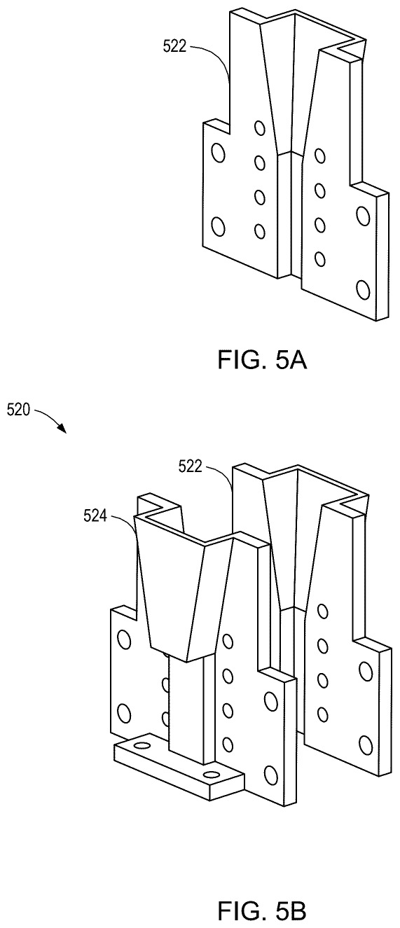

FIG. 5A illustrates the first half 522 of a split block horn, according to one embodiment. The illustrated embodiment shows the first half 522 of a square horn, but it is appreciated that the horn may be circular, a polygon, an oval, a circle, or other shape, as appreciated by those of skill in the art.

FIG. 5B illustrates the first half 522 and the second half 524 of the split block horn, according to one embodiment. The two halves (first half 522 and second half 524) of the split block horn are assembled together to form a functional antenna horn.

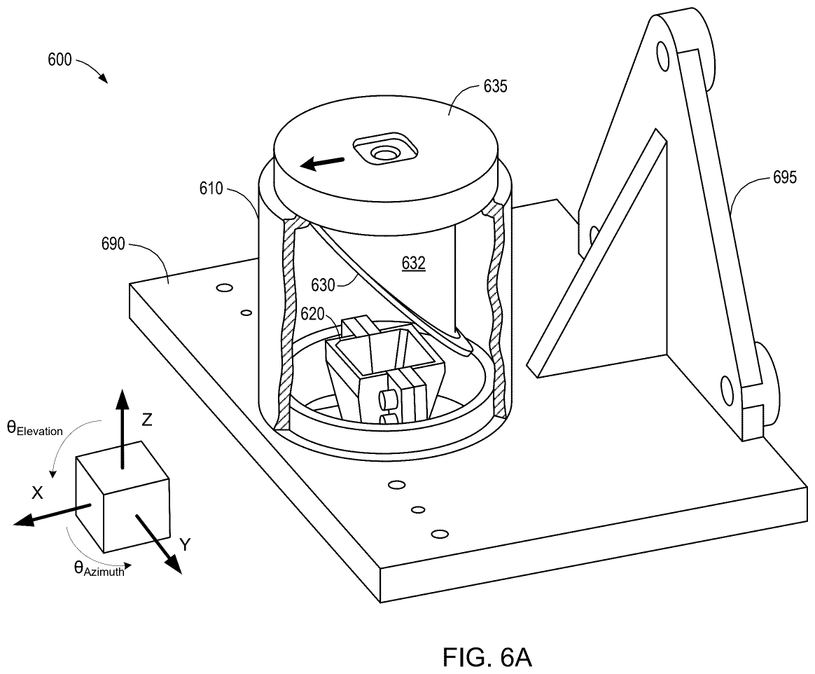

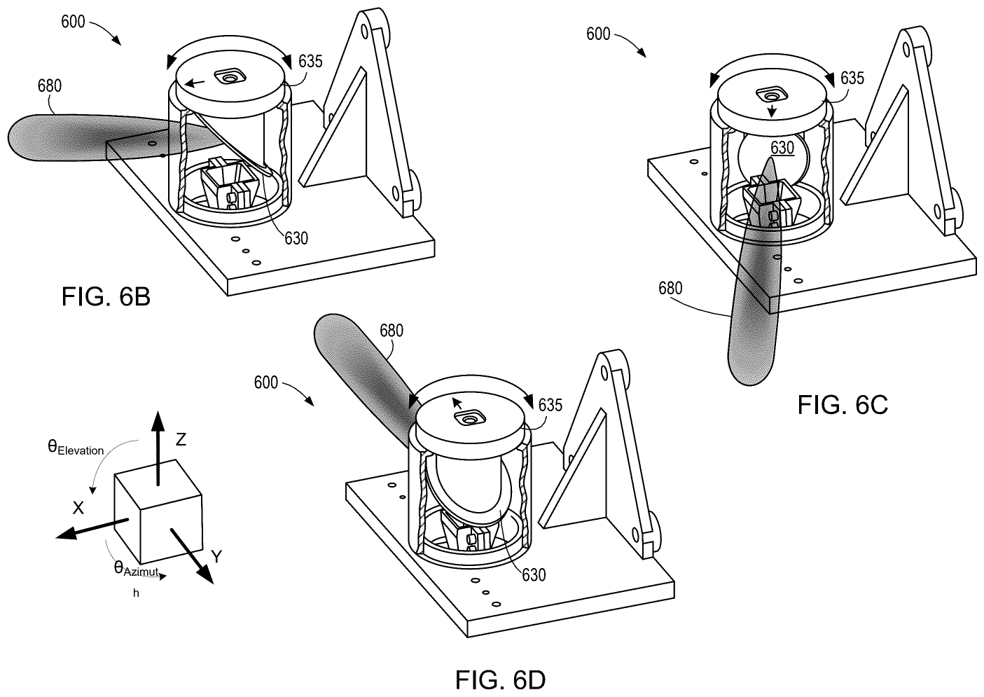

FIG. 6A illustrates a perspective view of an example steerable antenna device 600 with a mounting structure 690, according to one embodiment. In the illustrated example, the support is a cylindrical housing 610. The cylindrical housing 610 is mounted to the mounting structure 690. The mirror 630 is rotatably secured to the cylindrical housing 610. The cylindrical housing 610 positions the cylindrical housing 610 at a target distance from the horn antenna 620, such that beamformed radiation from the horn antenna 620 is reflected by the mirror 630 in a steered direction. The mirror 630 is rotated about the azimuth axis to select an azimuth angle for the reflected steering direction. The tilt angle of the mirror 630 (illustrated at approximately 45 degrees) is used to select the elevation angle of the steered radiation. The mounting structure 690 may include a lateral mounting component 695 as well.

In some embodiments, the tilt angle of the mirror 630 is fixed. In other embodiments, the title angle of the mirror 630 is adjustable between a range of usable angles (e.g., between approximately 25 and 65 degrees). In some embodiments, a smaller range of tilt adjustability, such as between 35 and 55 degrees, may be provided. In the illustrated example, the mirror 630 is rotatably connected to the cylindrical housing 610 via a mirror support 632. The mirror support 632 is connected to a knob 635. The example knob 635 is relatively large and overlaps the upper lip of the cylindrical housing 610. Rotation of the knob 635 causes the mirror support 632 and the mirror 630 to rotate relative to the cylindrical housing 610 and the fix-mounted horn antenna 620 and underlying transmitter, transceiver, or receiver.

FIG. 6B illustrates the steerable antenna device 600 with the mirror 630 rotated for beam steering at a first azimuth angle, according to one embodiment. The directed beam 680 can be rotated to a different azimuth angle (e.g., between 0 and 360 degrees) by rotating the knob 635.

FIG. 6C illustrates the steerable antenna device 600 with the mirror 630 rotated for beam steering at a second azimuth angle, according to one embodiment. An arrow on the top of the knob 635 may help an operator know the direction in which the directed beam 680 is steered. As previously noted, all embodiments described herein in the context of transmitting electromagnetic radiation can be used for receiving electromagnetic radiation. In many implementations, the embodiments of this disclosure are configured for use in a transceiver for steerable transmitting and steerable receiving.

FIG. 6D illustrates the steerable antenna device 600 with the mirror 630 rotated for beam steering at a third azimuth angle, according to one embodiment. The steerable antenna device 600 may include a larger or smaller knob 635. In some embodiments, the knob 635 may include degree marks for the azimuth angle. As previously noted, the tilt angle of the mirror 630 can be modified during manufacturing, during installation, and/or after installation.

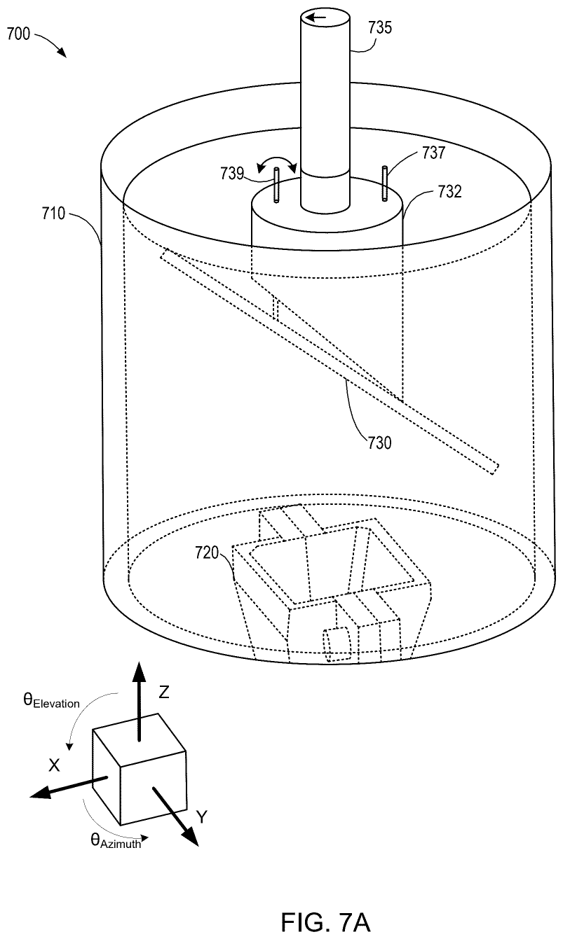

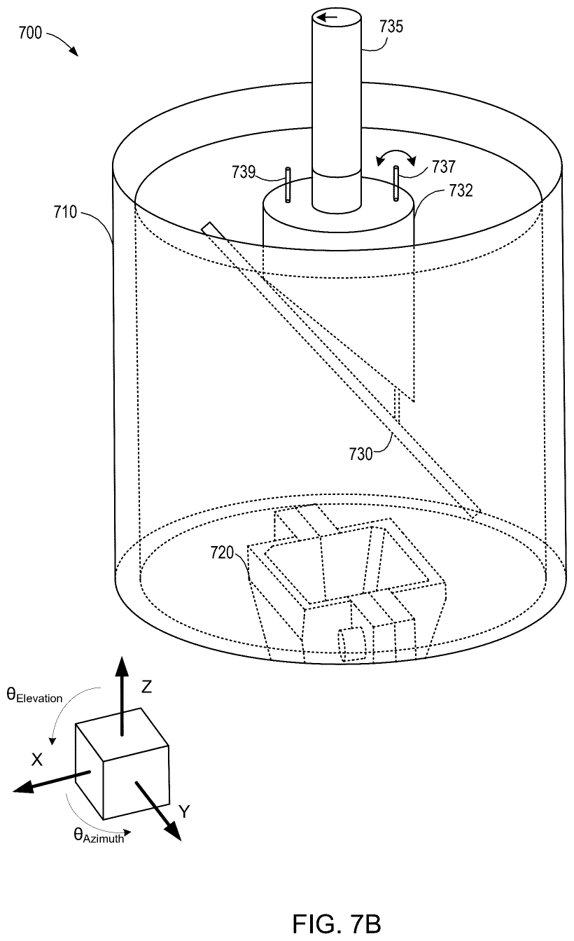

FIG. 7A illustrates an example steerable antenna device 700 with a mirror 730 selectively tilted to a lower elevation angle, according to one embodiment. As in previously described embodiments, the steerable antenna device 700 includes a horn 720 that is fixed in place with respect to a support. The support comprises a cylindrical housing 710. The horn 720 and any underlying transceiver, receiver, or transmitter remain stationary with respect to the cylindrical housing 710. The mirror 730 is rotatably connected to the cylindrical housing 710 via a mirror support 732. A knob 735 is used to rotate the mirror 730 relative to the cylindrical housing 710.

In the illustrated example, adjustment shafts 739 and 737 are used to selectively adjust the tilt angle of the mirror 730. For example, the adjustment shaft 739 (e.g., a slide screw or set screw) may be rotated to lower the tilt angle of the mirror 730 relative to the zenith axis along which the radiation is transmitted (or received) by the horn 720.

FIG. 7B illustrates the steerable antenna device 700 with the mirror 730 selectively tilted to a higher elevation angle, according to one embodiment. The adjustment shaft 737 is rotated to lower the tilt angle of the mirror 730 relative to the zenith axis along which the radiation is transmitted (or received) by the horn 720.

In another embodiment, the mirror may be secured to a support or framework via a U-shaped bracket. The U-shaped bracket may be connected to the edges of the mirror to allow the mirror to be tilted to any angle. In some embodiments, the mirror may be friction fit within the U-shaped bracket and/or rotated via a set of ratchets or other preset tilt angles.

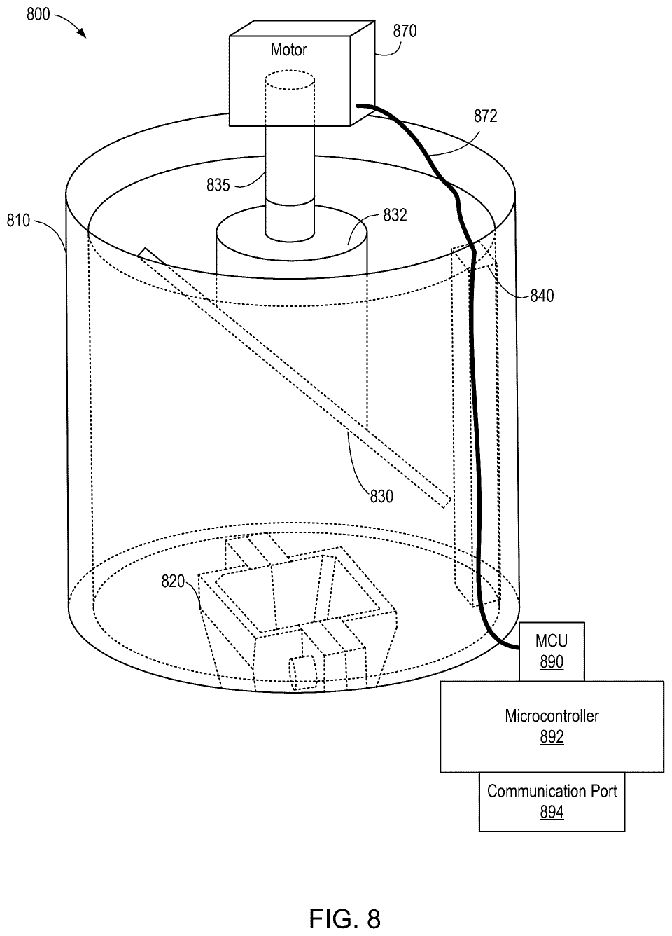

FIG. 8 illustrates a steerable antenna device 800 with motorized mirror control, according to one embodiment. The illustrated embodiment includes a fixed horn 820 positioned for transmitting and/or receiving radiation (e.g., microwave or millimeter wave) along a zenith axis. The mirror 830 is rotatably secured to the cylindrical housing 810 or other support, such as a framework or pillars. The mirror 830 is positioned to redirect the beam steering from the zenith axis to a steering angle definable in terms of an azimuth angle and an elevation angle.

Similar to previously described embodiments, the mirror 830 is rotatably connected to the cylindrical housing 810 via a mirror support 832. The mirror support 832 is connected to a mirror shaft 835. The mirror shaft 835 is selectively rotated by a motor 870, such as a rotating motor. The motor 870 may be connected to motor control unit 890 (MCU) via a wire 872. The wire 872 may extend down a strut 840 to ensure it is not tangled within the rotatable mirror 830. The mirror 830 may be rotated about the zenith axis for azimuth steering in 360 degrees. Alternatively, the strut 840 may prevent the rotation of the mirror 830 to some angles or block transmission.

In some embodiments, the motor control unit 890 may be controlled by a control unit, such as a microcontroller 892. In some embodiments, the microcontroller 892 may have a wired or wireless communication port 894 that allows for electronic control of the rotation of the mirror 830. For example, the wireless communication port 894 may utilize Wi-Fi, Bluetooth, or another communication protocol. The steerable antenna device 800 may be part of a mesh network or Internet of Things (IoT) group of products that utilize a customizable, standardized, or proprietary communication protocol.

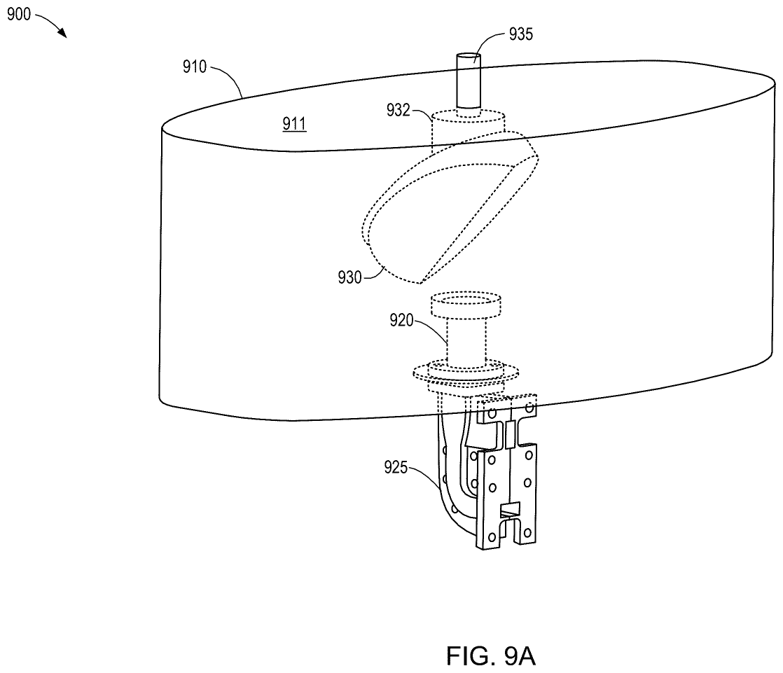

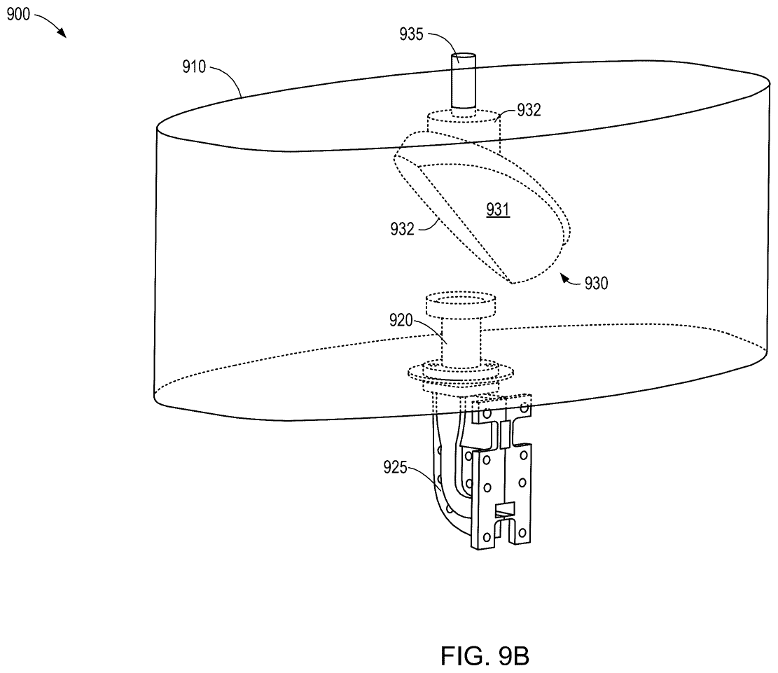

FIG. 9A illustrates a perspective view of an example steerable antenna device 900 with a wedge mirror 930 at a first azimuth angle, according to one embodiment. The wedge mirror 930 is rotatably connected to the housing 910 via a mirror support 932. The mirror support 932 may be, for example, rotatably connected to the top 911 or lid of the housing 910. In some embodiments, the mirror support 932 may be rotatably connected to the housing 910 using bearings, an axle, friction fittings, and/or other thru-bore connections. A knob 935 extends from the mirror support 932 through the top 911 or second end of the housing 910. The knob 935 can be rotated to rotate the mirror 930 within the housing 910. The wedge mirror 930 operates to reflect radiation to (or from) two different azimuthal directions at the same time. The angle of wedge mirror 930 is selected to achieve a target angular separation between the two different azimuthal scanning directions.

In the illustrated example, the steerable antenna device includes a circular horn 920 and orthogonal mode transducer 925 (e.g., with planar outputs). The transducer 925 and the circular horn 920 operate as a directive antenna to transmit beamformed radiation along the vertical axis (Z-axis) or zenith of the steerable antenna device 900. As in other embodiments, any of a wide variety of transmitters, receivers, or transceivers may be utilized instead of an orthogonal mode transducer 925 and circular horn 920. The mirror wedge mirror 930 operates to reflect the radiation transmitted along the vertical axis at a 90-degree angle (or another angle if the mirror is tilted to an angle other than 45 degrees relative to the zenith) in two different azimuthal angles.

FIG. 9B illustrates a perspective view of the steerable antenna device 910 of FIG. 9A with the wedge mirror 930 rotated to a second azimuth angle, according to one embodiment. Each face 931 and 932 of the wedge mirror 930 may be flat, symmetrically concave to increase directivity, and/or asymmetrically concave or curved to modify the shape of a reflected beam in each of the two different azimuthal direction. In various embodiments, the mirror shape may be selected to achieve target focusing or defocusing effects. In various embodiments, each face 931 and 932 of the wedge mirror 930 can be swapped with a mirror having a different shape before or after installation without any modification to the antenna or other components.

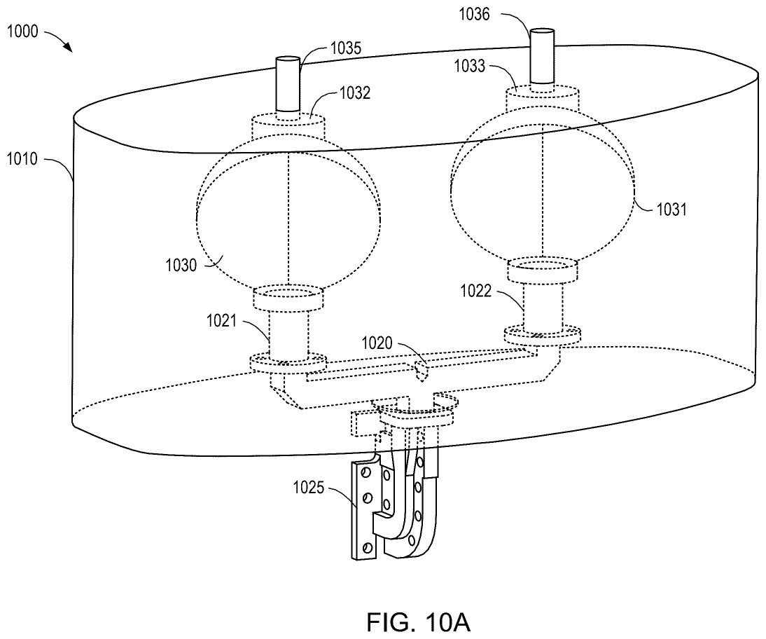

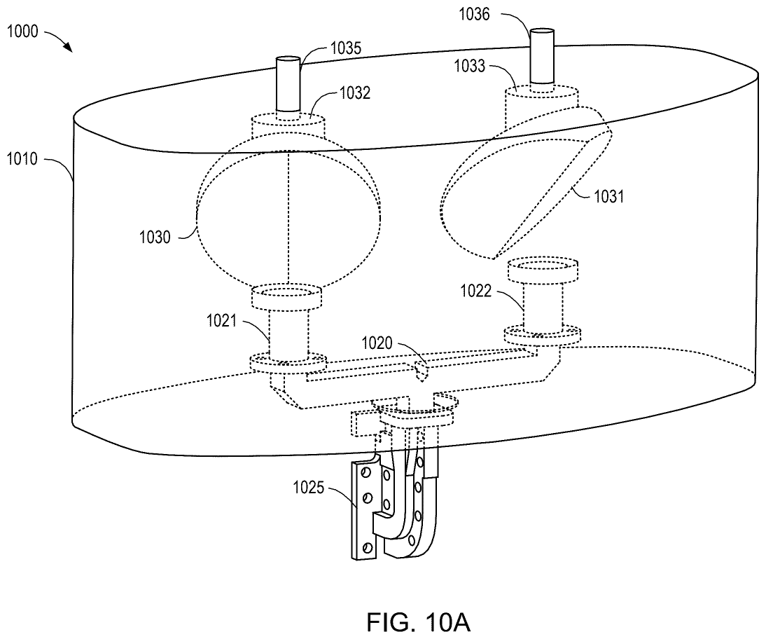

FIG. 10A illustrates a perspective view of an example steerable antenna device 1000 with dual rotatable wedge mirrors 1030 and 1031 rotated to two independent azimuth angles, according to one embodiment. The first wedge mirror 1030 is rotatably connected to the housing 1010 via a first mirror support 1032. A first knob 1035 extends from the first mirror support 1032 to facilitate independent rotation of the first wedge mirror 1030 within the housing 1010. The second wedge mirror 1031 is rotatably connected to the housing 1010 via a second mirror support 1033. A second knob 1036 extends from the second mirror support 1033 to facilitate independent rotation of the second wedge mirror 1031 within the housing 1010.

A transducer 1025 (e.g., an orthogonal mode transducer with planar outputs) is connected to a splitter 1020 that divides and directs the electromagnetic radiation into the first circular horn 1021 and the second circular horn 1022. The first horn 1021 is positioned to transmit microwave radiation toward the second end of the housing 1010 along a first radiation path that defines the first zenith axis for beam steering by the first wedge mirror 1030. The second horn 1022 is positioned to transmit microwave radiation toward the second end of the housing 1010 along a second radiation path that defines the second zenith axis for beam steering by the second wedge mirror 1031.

Each of the first wedge mirror 1030 and the second wedge mirror 1031 can be independently steered to different azimuth angles. In some embodiments, a steerable antenna device 10009 may include dual rotating mirrors that are non-wedge shaped. For example, the face of each of the two mirrors may be flat, symmetrically concave to increase directivity, and/or asymmetrically concave or curved to modify the shape of a reflected beam in each of the two different azimuthal direction. In various embodiments, the mirror shape may be selected to achieve target focusing or defocusing effects.

FIG. 10B illustrates a perspective view of the steerable antenna device 1000 of FIG. 10A with dual rotatable wedge mirrors 1030 and 1031 rotated to two different independent azimuth angles, according to one embodiment. As illustrated, the second wedge mirror 1031 is rotated to a different azimuth angle than the first wedge mirror 1030.

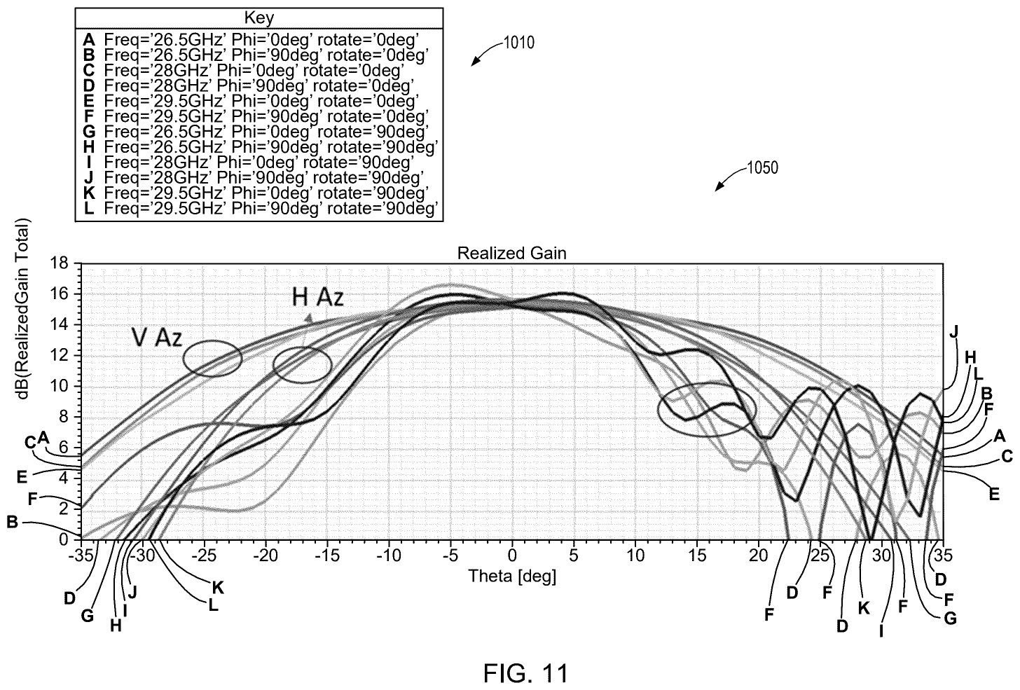

FIG. 11 illustrates a graph 1150 of the gain achieved by an example steerable antenna device at various steering angles for various frequencies, according to one embodiment. Numerous frequencies are identified in the key 1110 and are labeled with letters from A-L. The gain achieved for the various frequency bands relative to the azimuth steering angle of a rotatable mirror is shown using different shading and with letter labels A-L.

The embodiments of the systems and methods provided within this disclosure are not intended to limit the scope of the disclosure but are merely representative of possible embodiments. In addition, the steps of a method do not necessarily need to be executed in any specific order or even sequentially, nor do the steps need to be executed only once. Descriptions and variations described in terms of transmitters are equally applicable to receivers and vice versa.

This disclosure includes various examples and embodiments, including the best mode. However, those skilled in the art will recognize that changes and modifications may be made to the exemplary embodiments without departing from the scope of the present disclosure. While the principles of this disclosure are shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. This disclosure encompasses and includes at least the following claims.

What is claimed is:

1. A steerable antenna device, comprising:
a support with a first end and a second end;
a horn antenna positioned with respect to the first end of the support to transmit microwave radiation toward the second end of the support along a first radiation path that defines a zenith axis for beam steering;
a mirror rotatably secured to the second end of the support and positioned within the first radiation path to reflect the microwave radiation as beam-steered microwave radiation, wherein the mirror is:
selectively tiltable relative to the zenith axis to control an elevation angle of the beam-steered microwave radiation, and
selectively rotatable around the zenith axis to control an azimuth angle of the beam-steered microwave radiation; and
a knob connected to the mirror to facilitate manual rotation of the mirror around the zenith axis with respect to the support.

2. The steerable antenna device of claim 1, wherein the mirror is tilted at a fixed angle of 45 degrees relative to the zenith axis.

3. The steerable antenna device of claim 1, wherein the support comprises a housing that is electrically transparent in all azimuth directions.

4. The steerable antenna device of claim 3, wherein the housing comprises one of a circular cylindrical housing and an elliptical cylindrical housing.

5. The steerable antenna device of claim 1, wherein the support comprises a framework.

6. The steerable antenna device of claim 1, wherein a reflective surface of the mirror comprises one of an asymmetrical surface, concave surface, a convex surface, a faceted surface, and a wedge-shaped surface.

7. The steerable antenna device of claim 6, wherein the reflective surface of the mirror is rotatable about a rotational axis substantially perpendicular to the reflective surface.

8. The steerable antenna device of claim 1, further comprising an adjustment shaft to adjust a tilt angle of the mirror relative to the zenith axis.

9. The steerable antenna device of claim 8, wherein the tilt angle of the mirror is adjustable relative to the zenith axis.

10. A steerable antenna device, comprising:
a support with a first end and a second end;
an antenna positioned with respect to the first end of the support to transmit electromagnetic radiation toward the second end of the support along a first radiation path that defines a zenith axis for beam steering; and
a mirror rotatably secured to the second end of the support and positioned within the first radiation path to reflect the electromagnetic radiation as beam-steered electromagnetic radiation, wherein the mirror is:
tilted at an angle relative to the zenith axis to control an elevation angle of the beam-steered electromagnetic radiation, and
selectively rotatable around the zenith axis to control an azimuth angle of the beam-steered electromagnetic radiation.

11. The steerable antenna device of claim 10, wherein the mirror is tilted at a fixed angle between 30 and 60 degrees relative to the zenith axis.

12. The steerable antenna device of claim 10, further comprising a knob connected to the mirror, wherein the knob is configured to be manually rotated to rotate the mirror around the zenith axis.

13. The steerable antenna device of claim 10, wherein the a reflective surface of the mirror comprises one of an asymmetrical surface, concave surface, a convex surface, a faceted surface, and a wedge-shaped surface, and wherein the mirror is configured to modify a beam shape of the beam-steered electromagnetic radiation.

14. The steerable antenna device of claim 13, wherein the reflective surface of the mirror is rotatable about a rotational axis substantially perpendicular to the reflective surface.

15. The steerable antenna device of claim 10, further comprising an electronically controlled motor to selectively rotate the mirror around the zenith axis.

16. The steerable antenna device of claim 10, wherein the support comprises one of a: housing and a framework.

17. The steerable antenna device of claim 10, wherein the support comprises a housing that is electrically transparent in all azimuth directions.

18. The steerable antenna device of claim 17, wherein the housing comprises one of a circular cylindrical housing and an elliptical cylindrical housing.

19. The steerable antenna device of claim 10, wherein the antenna comprises a horn antenna.

20. The steerable antenna device of claim 10, wherein the antenna comprises a patch antenna.

21. The steerable antenna device of claim 10, wherein the antenna is configured to transmit one of: microwave radiation and millimeter wave radiation.

22. The steerable antenna device of claim 10, wherein a reflective surface of the mirror comprises an asymmetrical surface, wherein the mirror is additionally rotatable about a rotational axis perpendicular to the reflective surface, wherein rotation of the mirror about the rotational axis modifies a polarization of the beam-steered electromagnetic radiation.

23. The steerable antenna device of claim 10, further comprising an adjustment shaft to adjust a tilt angle of the mirror relative to the zenith axis.

24. The steerable antenna device of claim 23, wherein the adjustable shaft is driven with an electronically controlled linear actuator.

25. The steerable antenna device of claim 24, wherein the tilt angle of the mirror is adjustable between 15 degrees and 75 degrees relative to the zenith axis.

26. A steerable antenna device, comprising:
a housing;
a transducer to generate a signal;
a splitter to divide the signal between first and second outputs;
a first horn antenna positioned on the first output to transmit the signal along a first radiation path that defines a first zenith axis for beam steering;
a first mirror rotatably secured to the housing and positioned within the first radiation path to reflect the signal as first beam-steered signal, wherein the first mirror is selectively rotatable around the first zenith axis to control an azimuth angle of the first beam-steered the signal; and
a first knob for rotation of the first mirror around the first zenith axis;
a second horn antenna positioned on the second output to transmit the signal along a second radiation path that defines a second zenith axis for beam steering;
a second mirror rotatably secured to the housing and positioned within the second radiation path to reflect the signal as second beam-steered signal, wherein the second mirror is selectively rotatable around the second zenith axis to control an azimuth angle of the second beam-steered signal; and
a second knob for rotation of the second mirror around the second zenith axis.

27. The steerable antenna device of claim 26, wherein the first mirror is selectively tiltable relative to the first zenith axis to control an elevation angle of the first beam-steered signal, and wherein the second mirror is selectively tiltable relative to the second zenith axis to control an elevation angle of the second beam-steered signal.

28. The steerable antenna device of claim 26, wherein a reflective surface of each of the first mirror and the second mirror comprises one of an asymmetrical surface, concave surface, a convex surface, a faceted surface, and a wedge-shaped surface.
